(19) United States
(12) Patent Application Publication
(10) Pub. No.: US 2026/0180796 A1
(43) Pub. Date: Jun. 25, 2026

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventors: Sho NAGASE, Kanagawa (JP); Masahiko HARADA, Kanagawa (JP); Atsushi MORI, Kanagawa (JP); Ryosuke NAKAI, Kanagawa (JP)

(73) Assignee: FUJIFILM Business Innovation Corp., TOKYO (JP)

(21) Appl. No.: 19/202,390

(22) Filed: May 8, 2025

(30) Foreign Application Priority Data
Dec. 25, 2024 (JP) 2024-229267

(51) Int. Cl. H04L 9/08

(52) U.S. Cl. CPC H04L 9/088

(57) ABSTRACT

An information processing apparatus includes a processor configured to, when activation satisfies a predetermined condition, receive an input operation for a one-time password, and encrypt a first encryption key used to encrypt first encrypted data stored in a first storage device removable from a first board with the one-time password and store the encrypted first encryption key in the first storage device.

### CROSS-REFERENCE TO RELATED APPLICATIONS

This application is based on and claims priority under 35 USC 119 from Japanese Patent Application No. 2024-229267 filed Dec. 25, 2024.

### BACKGROUND

### (i) Technical Field

The present disclosure relates to an information processing apparatus and a non-transitory computer readable medium.

### (ii) Related Art

Printers and other devices are required to have high security for user data. For this reason, for example, the following conditions need to be satisfied.
(1) Data on a removable storage device is encrypted by a specific algorithm.
(2) A plain-text encryption key used for encryption is not stored in the same storage device as encrypted data.
(3) A plain-text encryption key is not stored in a removable storage device.

Examples of the related art include Japanese Unexamined Patent Application Publication No. 2016-111627.

### SUMMARY

When printers and other devices are repaired, a board may need to be replaced. In this case, the storage device is removed from the old board and installed onto the new board.

However, an encryption key used to encrypt data is associated with a board on a one-to-one basis. For this reason, even when the storage device of the old board is transferred to the new board, it is difficult to decrypt and use the data stored in the storage device as it is. This is because the encryption key of the old board used to encrypt the data is different from the encryption key of the new board.

Aspects of non-limiting embodiments of the present disclosure relate to increasing security for data as compared with a case where a plain-text encryption key is backed up in a removable storage device.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to: when activation satisfies a predetermined condition, receive an input operation for a one-time password; and encrypt a first encryption key used to encrypt first encrypted data stored in a first storage device removable from a first board with the one-time password and store the encrypted first encryption key in the first storage device.

### BRIEF DESCRIPTION OF THE DRAWINGS

Exemplary embodiments of the present disclosure will be described in detail based on the following figures, wherein:

FIG. 1 is a diagram illustrating an example of the configuration of an image forming apparatus;

FIG. 2 is a diagram illustrating an example of data stored in a non-volatile memory;

FIG. 3 is a flowchart illustrating an example of a part of a work procedure and a processing operation related to replacement of a control board;

FIG. 4 is a diagram illustrating an example of a menu screen displayed in the case of activation in a maintenance mode;

FIG. 5 is a diagram illustrating a processing operation in steps S104 to S105 of FIG. 3;

FIG. 6 is a diagram illustrating work to replace the control board by a customer engineer;

FIG. 7 is a flowchart illustrating an example of a work procedure and a processing operation executed when a negative result is obtained in step S109 of FIG. 3;

FIG. 8 is a flowchart illustrating an example of a processing operation executed when no encryption key data is recorded in a specific area of the non-volatile memory;

FIG. 9 is a diagram illustrating an example of a menu screen displayed at the time of first activation after the control board is replaced; and

FIG. 10 is a diagram illustrating an example of a processing operation executed at the time of the first activation after the control board is replaced.

### DETAILED DESCRIPTION

Exemplary embodiments of the disclosure will be described below with reference to the drawings.

### First Exemplary Embodiment

### Configuration of Image Forming Apparatus

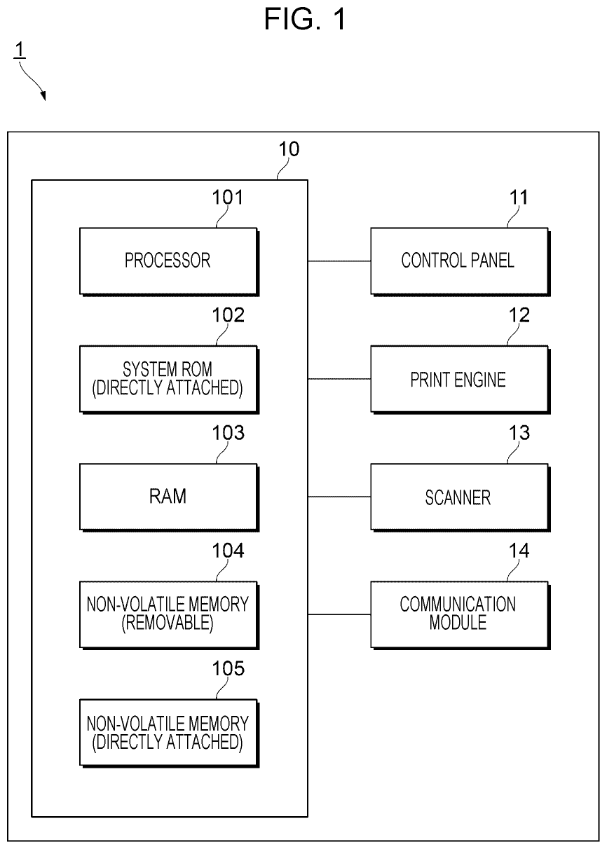

FIG. 1 is a diagram illustrating an example of the configuration of an image forming apparatus 1. The image forming apparatus 1 is an example of an information processing apparatus.

The image forming apparatus 1 includes, for example, a control board 10, a control panel 11, a print engine 12, a scanner 13, and a communication module 14.

The control panel 11 is a device that receives user operations. The control panel 11 is provided with, for example, a touch panel, a button, and a switch. The touch panel is, for example, a device having a structure in which capacitive translucent thin-film sensors are stacked on the surface of a display. The touch panel is an example of a device having functions of both an input device and an output device. The button and the switch are examples of a mechanical operator. Hereinafter, various screens displayed on the touch panel are also referred to as the “operation screen”.

The print engine 12 includes a processing device and associated mechanisms used to print information on paper or other media.

Examples of the processing device include functional units related to rasterizing processing, density correction, sharpness correction, contrast correction, and background color removal.

The mechanism of the print engine 12 varies depending on the printing method. For example, the mechanism of the print engine 12 differs between a photographic printing method and an inkjet method.

A mechanism (i.e., a transport mechanism) for transporting a medium varies depending on whether the medium is cut paper or roll paper.

The scanner 13 is a device that optically reads information on the surface of a document. The scanner 13 supports at least one of the following methods: the method of moving a reading unit relative to a document in a stationary state; and the method of moving a document relative to a reading unit in a stationary state.

The communication module 14 is a module that enables communications with an external terminal. Examples of the communication module 14 include a module used for connection to a wired or wirelessly connected local area network (LAN). Further, examples of the communication module 14 include a universal serial bus (USB) module.

The control board 10 includes, for example, a processor 101, a system read only memory (ROM) 102, a random access memory (RAM) 103, a non-volatile memory 104 removable from the control board 10, and a non-volatile memory 105 directly attached to the control board 10.

The non-volatile memory 105 directly attached to the control board 10 is a storage device that is unremovable from the control board 10. The non-volatile memory 105 is an example of a second storage device.

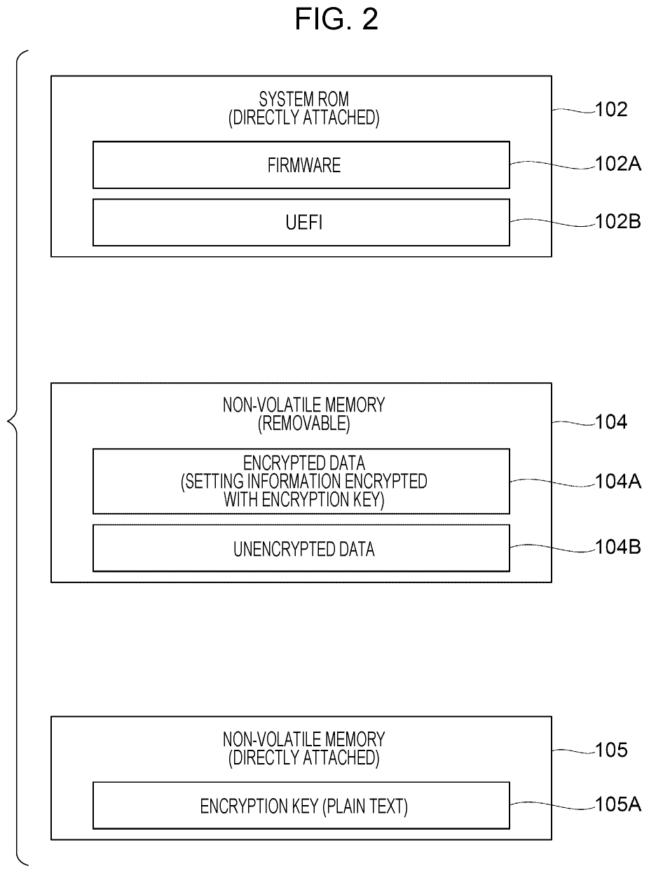

The processor 101 is a semiconductor device that performs various functions by executing programs. Examples of the programs here include a firmware 102A (see FIG. 2) and a unified extensible firmware interface (UEFI) 102B (see FIG. 2).

The firmware 102A is a program that controls operations and functions of the control panel 11 and other devices included in the image forming apparatus 1.

The UEFI 102B is a boot program that controls an activation process. In the UEFI 102B, for example, a customer engineer mode (hereinafter also referred to as “maintenance mode”) is provided. The customer engineer mode is executed when the activation satisfies a predetermined condition.

The system ROM 102 is directly attached to the control board 10. That is, the system ROM 102 is a storage device that is physically unremovable from the control board 10 by a customer engineer or the like. The system ROM 102 is, for example, soldered to the control board 10.

The RAM 103 is a semiconductor memory used as, for example, a program execution area. For example, the processor 101, the system ROM 102, and the RAM 103 constitute a computer.

The non-volatile memory 104 is a storage device that is removal from the control board 10. Examples of the non-volatile memory 104 include a Secure Digital (SD) memory card, a hard disk device (that is, a magnetic recording device), and a ROM soldered to a sub-board connected to the control board 10 via a connector.

The non-volatile memory 104 stores, for example, encrypted data 104A (see FIG. 2) and unencrypted data 104B (see FIG. 2).

The encrypted data 104A refers to, for example, the setting information that is encrypted with an encryption key 105A (see FIG. 2) unique to the control board 10. Examples of the setting information include user information and security information. Examples of the user information here include the information for identifying a user, user settings for various functions, a usage log, and an error log.

The unencrypted data 104B is data stored in an unencrypted form.

The non-volatile memory 105 is a storage device directly attached to the control board 10. Examples of the non-volatile memory 105 include an electrically erasable programmable (EEP) ROM, a flash ROM, and a trusted platform module (TPM).

The non-volatile memory 105 stores a plain-text encryption key 105A. This is to satisfy the requirement that the encrypted data 104A and the plain-text encryption key 105A used to encrypt the encrypted data 104A are prevented from being stored in the same storage device.

The initial value of the encryption key 105A is unique to the control board 10. However, the user may generate and use a different key.

FIG. 2 is a diagram illustrating an example of data stored in the non-volatile memory.

As described above, the system ROM 102 stores, for example, the firmware 102A and the UEFI 102B.

The non-volatile memory 104, which is removable from the control board 10 (see FIG. 1), stores for example the encrypted data 104A and the unencrypted data 104B.

The non-volatile memory 105, which is directly attached to the control board 10, stores the plain-text encryption key 105A.

### Control Board Replacement Work and Processing Operation

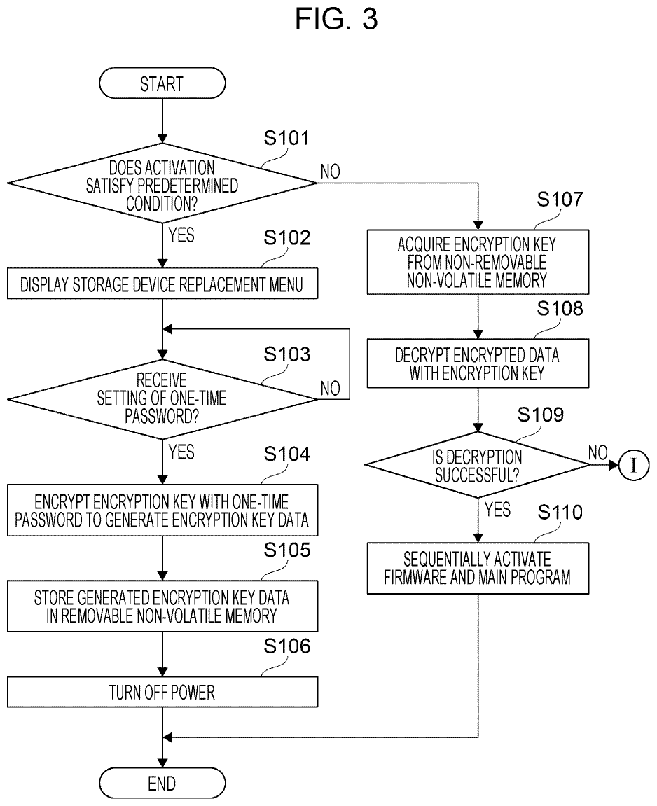

FIG. 3 is a flowchart illustrating an example of a part of a work procedure and a processing operation related to the replacement of the control board 10 (see FIG. 1). In the drawings, the symbol “S” represents a step.

The processing operation illustrated in FIG. 3 is performed by the processor 101 (see FIG. 1) executing the UEFI 102B (see FIG. 2).

First, the processor 101 determines whether the activation satisfies a predetermined condition (step S101). As the predetermined condition, a specific operation assigned to the preparation for replacement of the control board 10 is assumed. Examples of activation by a specific operation include activation in a state where a specific key is pressed, activation in a state where a specific switch is at a specific position, and activation in a state where a predetermined device is inserted. For example, when any one of these conditions is satisfied, it is determined that the predetermined condition is satisfied.

Examples of the specific key include a home button, a job check button, a clear button, a pause button, an interrupt button, a stop button, a start button, a reset button, and a machine check (meter check) button. According to the exemplary embodiment, the activation with any one of the buttons pressed is assumed, but the activation may be performed with a plurality of predetermined buttons pressed at the same time. These buttons are physical keys.

Examples of the specific switch include a DIP switch and a lever switch.

The DIP switch may be of a slide type, a piano type, or a rotary type. The DIP switch may include a plurality of switches. When a plurality of switches is included, for example, the activation of the maintenance mode is assigned to a predetermined specific switch.

With regard to the lever switch, the number of directions in which the lever is tilted may be two or more. In this case, a state where the lever is inclined in a specific direction is referred to as a “state where a specific switch is at a specific position”. A power switch is also included in the lever switch. These switches are also physical keys.

When the activation satisfies the predetermined condition, a positive result is obtained in step S101. In this case, the processor 101 displays a storage device replacement menu (step S102).

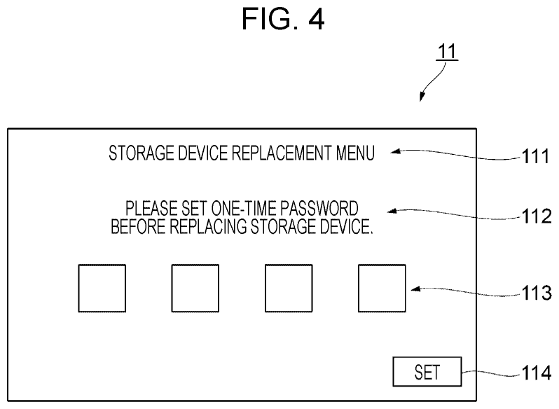

FIG. 4 is a diagram illustrating an example of a menu screen displayed in the case of the activation in the maintenance mode. This menu screen is displayed on the control panel 11 of the image forming apparatus 1 (see FIG. 1). The menu screen is an example of a maintenance mode screen.

The screen example illustrated in FIG. 4 includes a title 111, an explanatory text 112, an input field 113 for a one-time password, and a setting button 114.

For example, “storage device replacement menu” is displayed in the title 111.

An instruction for the customer engineer or the like is described in the explanatory text 112. In the case of FIG. 4, “Please set a one-time password before replacing the storage device” is displayed in the explanatory text 112.

In the case of FIG. 4, an input field for a four-digit character string (for example, a number from 0 to 9999) is provided as the input field 113 for a one-time password. Four digits are an example, and input of a character string of five or more digits may be requested. The greater the number of digits, the greater the security. The character type used for the one-time password is not limited to numerals, and may include alphabets and symbols.

Input of a character string into the input field 113 is an example of an input operation.

According to the present exemplary embodiment, the period during which the one-time password is valid is, for example, 10 minutes. However, the validity period is not limited to 10 minutes and may be longer or shorter than 10 minutes. An input field for confirmation may be separately provided.

In the case of FIG. 4, when the setting button 114 is operated, the input of the one-time password is confirmed.

When the entire input field is filled with characters, the input may be confirmed, or when a character string input to the input field 113 for a one-time password matches a character string input to the input field for confirmation, the input may be confirmed. When these functions are employed, the setting button 114 is unnecessary.

A reference is made back to the description of FIG. 3.

After step S102 is performed, the processor 101 determines whether the setting of a one-time password has been received (step S103).

When the setting of a one-time password is incomplete, a negative result is obtained in step S103. In this case, the processor 101 repeats the determination in step S103.

When the setting of a one-time password is complete, a positive result is obtained in step S103. In this case, the processor 101 encrypts the encryption key with the one-time password to generate encryption key data (step S104). The plain-text encryption key 105A (see FIG. 2) is stored in the non-volatile memory 105 (see FIG. 2).

Subsequently, the processor 101 stores the generated encryption key data in the removable non-volatile memory 104 (see FIG. 2) (step S105).

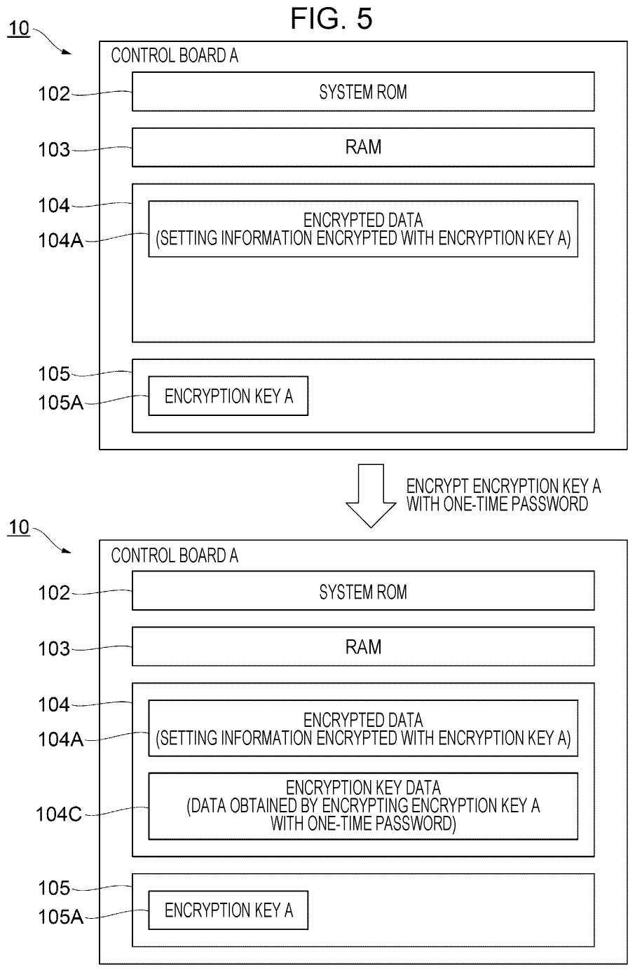

FIG. 5 is a diagram illustrating a processing operation in steps S104 to S105.

In FIG. 5, the control board 10 mounted on the image forming apparatus 1 (see FIG. 1) is referred to as the “control board A”. The “control board A” is the control board 10 where a failure or the like has occurred. In FIG. 5, the encryption key 105A stored in the non-volatile memory 105 directly attached to the control board 10 is referred to as the “encryption key A”. The “encryption key A” is the encryption key unique to the “control board A”.

The “control board A” is an example of a first board.

The non-volatile memory 104 attached to the “control board A” is an example of a first storage device.

The encrypted data 104A stored in the non-volatile memory 104 is an example of first encrypted data.

The “encryption key A” used to encrypt the encrypted data 104A is an example of a first encryption key.

As described above in step S104, when the setting of the one-time password is received, the “encryption key A” is encrypted with the one-time password and stored as encryption key data 104C in the non-volatile memory 104.

As a result, the encrypted data 104A and the encryption key data 104C are stored in the non-volatile memory 104.

As described above, from the viewpoint of security, the encrypted data 104A and the plain-text “encryption key A” used to generate the encrypted data 104A are not allowed to be stored in the same storage device. Also, the plain-text “encryption key A” is not allowed to be stored in the non-volatile memory 104 that is removable from the control board 10.

However, according to the present exemplary embodiment, the encryption key data 104C obtained by encrypting the “encryption key A” is stored in the non-volatile memory 104. Therefore, the two conditions described above are satisfied.

A reference is made back to the description of FIG. 3.

When the encryption key data 104C (see FIG. 5) is stored in the non-volatile memory 104, the processor 101 turns off the power (step S106).

When the power is turned off, the control board 10 (see FIG. 1) can be removed from the image forming apparatus 1 (see FIG. 1).

According to the present exemplary embodiment, the customer engineer performs work to replace the board.

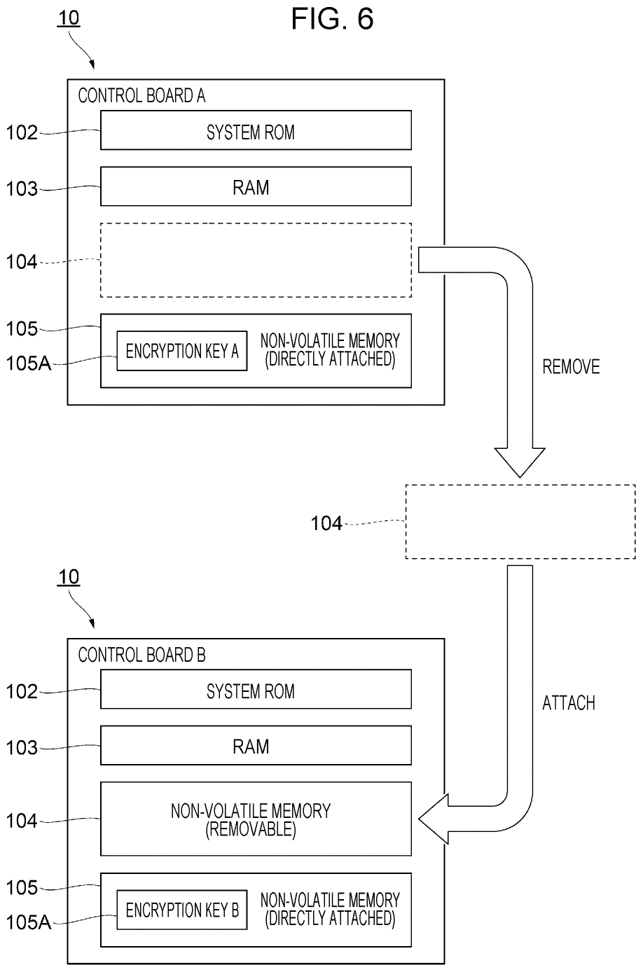

FIG. 6 is a diagram illustrating work to replace the control board 10 by the customer engineer. In FIG. 6, the parts corresponding to those in FIG. 5 are denoted by the corresponding reference numerals.

As illustrated in FIG. 6, the customer engineer removes the non-volatile memory 104 from the faulty control board 10 (i.e., the control board A) and attaches the non-volatile memory 104 to the different control board 10 (i.e., a control board B).

The “control board B” here is an example of a second board. The non-volatile memory 105 of the “control board B” stores an “encryption key B” as the encryption key 105A unique to the “control board B”. The “encryption key B” is an example of a second encryption key.

After attaching the “control board B”, to which the non-volatile memory 105 is completely attached, to the image forming apparatus 1, the customer engineer turns on the main power. When the main power is turned on, the UEFI 102B (see FIG. 2), which is a boot program, is activated.

A reference is made back to the description of step S101 in FIG. 3.

When the main power is turned on, the determination processing in step S101 is executed again.

When the activation satisfies the predetermined condition, the above-described operation is repeated. The activation that does not satisfy the predetermined condition will be described below. In this case, a negative result is obtained in step S101. Examples of the case where a negative result is obtained in step S101 include a case where the control board 10 (see FIG. 1) is operating normally or the activation is executed immediately after the control board 10 is replaced.

When a negative result is obtained in step S101, the processor 101 acquires the encryption key 105A (see FIG. 1) from the unremovable non-volatile memory 105 (see FIG. 1) (step S107).

When the control board 10 is operating normally (that is, when the control board 10 has not been replaced) and when the activation is executed immediately after the control board 10 is replaced, the acquired encryption key 105A is different. For example, when the control board 10 is operating normally, the “encryption key A” is acquired. Conversely, in a case where the control board 10 has been replaced, the “encryption key B” is acquired.

Subsequently, the processor 101 decrypts the encrypted data 104A (see FIG. 5) with the encryption key (step S108).

Then, the processor 101 determines whether the decryption is successful (step S109).

When the decryption is successful, a positive result is obtained in step S109. When the decryption is successful, for example, the control board 10 is operating normally. The case where the control board 10 is operating normally includes a case where the setting information has been taken over by the newly attached control board 10 (i.e., the control board B).

When a positive result is obtained in step S109, the processor 101 sequentially activates the firmware and the main program (step S110). The processor 101 executes the activation processing by using the decrypted setting information.

Conversely, when the decryption of the encrypted data fails, a negative result is obtained in step S109. Examples of the case where the decryption of the encrypted data fails include the activation immediately after the control board 10 is replaced.

The encrypted data 104A immediately after the control board 10 is replaced is the data stored in the non-volatile memory 104 taken over from the “control board A” as it is. That is, the data is encrypted with the “encryption key A”.

However, the encryption key to be used for decryption is the “encryption key B” read from the non-volatile memory 105 (see FIG. 6) of the “control board B” after replacement. In this case, since the encryption key used for encryption is different from the encryption key used for decryption, the decryption fails.

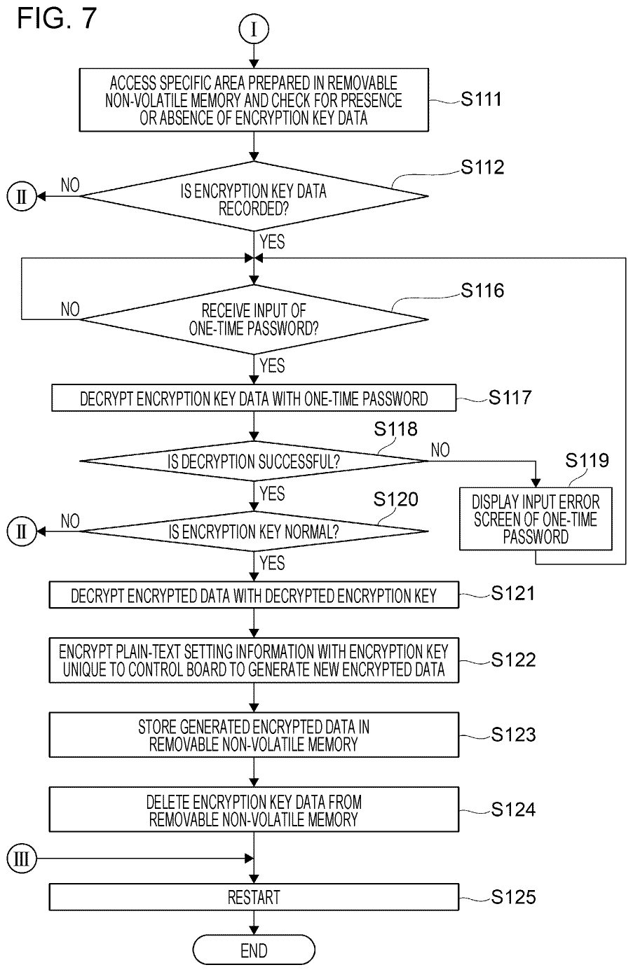

FIG. 7 is a flowchart illustrating an example of a work procedure and a processing operation executed when a negative result is obtained in step S109 (see FIG. 3).

When a negative result is obtained in step S109, the processor 101 accesses a specific area provided in the removable non-volatile memory 104 and checks for the presence or absence of the encryption key data 104C (see FIG. 5) (step S111).

According to the present exemplary embodiment, the specific area is previously defined. In other words, the use area of the non-volatile memory 104 is defined for each application. Therefore, the processor 101 accesses a recording area allocated to the encryption key data 104C (the data obtained by encrypting the encryption key A with the one-time password).

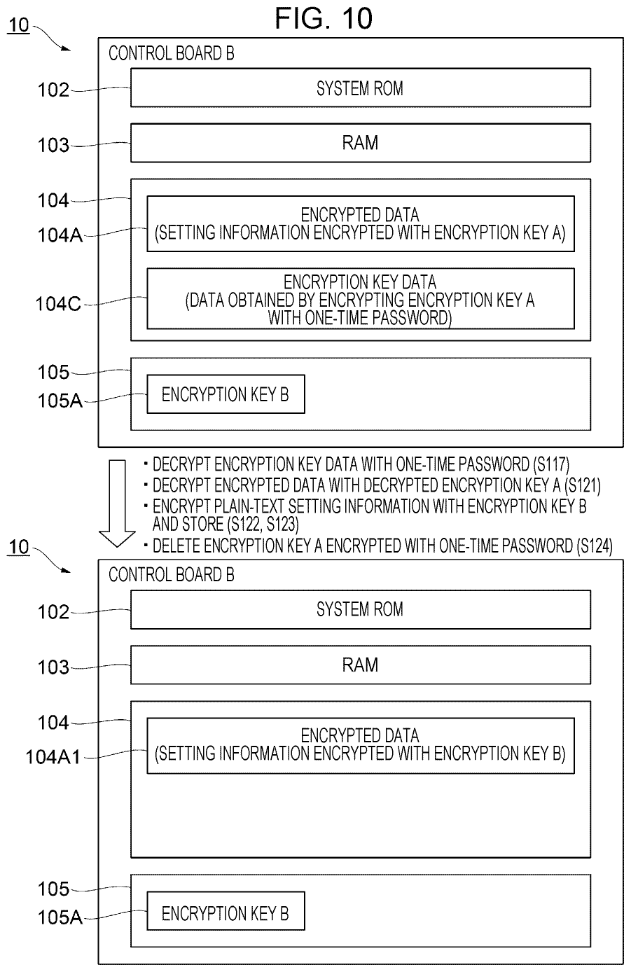

Subsequently, the processor 101 determines whether the encryption key data 104C (see FIG. 10) is recorded (step S112).

For example, when all-zero data is read, it is determined that no encryption key data is recorded. In this case, a negative result is obtained in step S112.

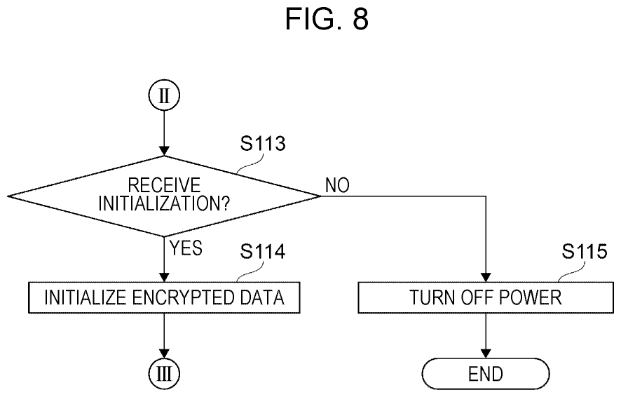

FIG. 8 is a flowchart illustrating an example of a processing operation executed when no encryption key data is recorded in a specific area of the non-volatile memory 104.

When a negative result is obtained in step S112, the processor 101 determines whether initialization has been received (step S113).

The control panel 11 (see FIG. 1) displays the inquiry to the customer engineer as to whether to execute initialization.

When the initialization is received from the customer engineer, a positive result is obtained in step S113. In this case, the processor 101 initializes the encrypted data 104A (step S114). Then, the processor 101 proceeds to step S125 (see FIG. 7). Specifically, the processor 101 proceeds to restart.

Conversely, when the initialization is not received, a negative result is obtained in step S113. In this case, the processor 101 turns off the power (step S115).

A reference is made back to the description of FIG. 7.

When the data having a predetermined data length (for example, 32 bits) is recorded in the specific area, it is assumed that the encryption key data is recorded. In this case, a positive result is obtained in step S112. When a positive result is obtained in step S112, the processor 101 determines whether input of a one-time password has been received (step S116).

The determination in step S116 may be performed only within the valid time of the one-time password. When the valid time has expired, another screen may be displayed to notify that the data takeover work is to be redone.

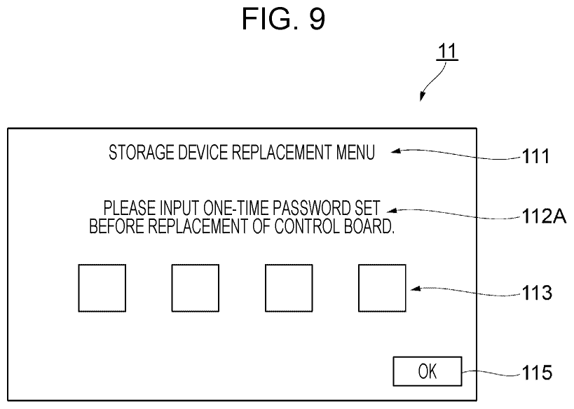

FIG. 9 is a diagram illustrating an example of a menu screen displayed at the time of first activation after the control board (see FIG. 1) is replaced. In FIG. 9, the parts corresponding to those in FIG. 4 are denoted by the corresponding reference numerals. This menu screen is an example of an input screen for a one-time password.

The screen example illustrated in FIG. 9 includes a title 111, an explanatory text 112A, an input field 113 for a one-time password, and an OK button 115.

For example, “storage device replacement menu” is displayed in the title 111.

In the explanatory text 112A, an instruction for the customer engineer or the like is described. In the explanatory text 112A illustrated in FIG. 9, “Please input the one-time password set before the replacement of the control board” is displayed.

In the case of FIG. 9, too, an input field for a four-digit character string (for example, a number from 0 to 9999) is provided as the input field 113 for a one-time password. The number of digits in the input field is the same as that in the menu screen illustrated in FIG. 4.

In the case of FIG. 9, when the OK button is operated, the input of the one-time password is confirmed.

When the entire input field is filled with characters, the input may be confirmed, or when a character string input to the input field 113 for a one-time password matches a character string input to the input field for confirmation, the input may be confirmed. When these functions are employed, the OK button 115 is unnecessary.

A reference is made back to the description of FIG. 7.

When the input of the one-time password is not confirmed, a negative result is obtained in step S116. In this case, the processor 101 repeats the determination in step S116.

Conversely, when the input of a one-time password is received, a positive result is obtained in step S116. In this case, the processor 101 decrypts the encryption key data 104C with the one-time password (step S117).

Subsequently, the processor 101 determines whether the decryption with the one-time password is successful (step S118).

When the decryption with the one-time password fails, a negative result is obtained in step S115. In this case, the processor 101 displays an input error screen of the one time-password (step S119). The input error screen is displayed on the control panel 11 (see FIG. 1). Afterward, the processor 101 returns to step S116 and prepares for the input of a new one-time password.

Conversely, when the decryption with the one-time password is successful, a positive result is obtained in step S118. In this case, the processor 101 determines whether the encryption key is normal (step S120). It is determined whether the encryption key is normal based on, for example, the data length. For example, it is assumed that the normal encryption key has a data length of 32 bits.

When the data length of the decrypted encryption key exceeds 32 bits, it is determined that the decrypted encryption key is “faulty”. In this case, a negative result is obtained in step S120. When a negative result is obtained in step S120, the processor 101 proceeds to the same step (i.e., step S113 (see FIG. 8)) as when a negative result is obtained in step S112.

Conversely, when it is determined that the decrypted encryption key is “normal”, a positive result is obtained in step S120. In this case, the processor 101 decrypts the encrypted data 104A with the decrypted encryption key (i.e., the encryption key A) (step S121). Through this decryption processing, plain-text setting information is generated. The plain-text setting information is temporarily stored in, for example, the RAM 103 (see FIG. 1). The plain-text setting information is an example of plain-text data.

Subsequently, the processor 101 encrypts the plain-text setting information with the encryption key (that is, the encryption key B) unique to the control board 10 (that is, the control board B) to generate new encrypted data 104A1 (see FIG. 10) (step S122). The encrypted data 104A1 is an example of second encrypted data.

Subsequently, the processor 101 stores the generated encrypted data 104A1 in the removable non-volatile memory 104 (step S123).

Afterward, the processor 101 deletes the encryption key data 104C (see FIG. 10) from the removable non-volatile memory 104 (step S124). The encryption key data 104C here is data obtained by encrypting the “encryption key A” with a one-time password.

The processor 101 then proceeds to restart (step S125).

FIG. 10 is a diagram illustrating an example of a processing operation executed at the time of the first activation after the control board 10 is replaced. In FIG. 10, the parts corresponding to those in FIGS. 5 and 6 are denoted by the corresponding reference numerals. The upper part of FIG. 10 illustrates a data storage state immediately after the control board 10 is replaced.

Therefore, the non-volatile memory 104 stores the encrypted data 104A (the setting information encrypted with the encryption key A) and the encryption key data 104C. Furthermore, the control board 10 illustrated in FIG. 10 is the new “control board B”. In the case of FIG. 10, the encryption key 105A stored in the non-volatile memory 105 is the “encryption key B”.

When steps S117 to S124 (see FIG. 7) are executed in the state illustrated in the upper part of FIG. 10, only the encrypted data 104A1 encrypted with the “encryption key B” is stored in the non-volatile memory 104, as illustrated in the lower part of FIG. 10. That is, the encryption key data (the data obtained by encrypting the encryption key A with the one-time password) 104C stored when the non-volatile memory 104 is attached to the new “control board B” is deleted.

### Summary

With the above-described mechanism, after the encryption key data (the data obtained by encrypting the encryption key with the one-time password) is stored in the non-volatile memory 104, the non-volatile memory 104 is removed from the current control board A. At this time, the non-volatile memory 104 stores two types of data, i.e., the encrypted data 104A and the encryption key data 104C.

However, the encryption key data 104C is not in plain text but is encrypted. Therefore, even when the non-volatile memory 104 is leaked outside, the plain-text setting information is prevented from being decrypted from the encryption key data 104C.

The only person who knows the one-time password is the customer engineer who has set the one-time password. Thus, the one-time password is received from the customer engineer after the non-volatile memory 104 is attached so that the encryption key 105A can be decrypted while ensuring the security. When the encryption key A is decrypted, the setting information can be decrypted on the control board B.

The decrypted setting information is encrypted with the encryption key B unique to the control board B and stored in the non-volatile memory 104. In any case, the setting information used in the control board A is stored in a state where the setting information can be used in the new control board B.

With the mechanism described according to the present exemplary embodiment, only the non-volatile memory 104 removable from the control board A is required. In other words, communications with an external terminal or the like are not required to import the encryption key A, which is used to encrypt the encrypted data 104A, into the new control board B.

Therefore, the above-described mechanism can be employed as long as there is the one non-volatile memory 104 removable from the control board A. Since there may be the one non-volatile memory 104 removable from the control board A, there may be the two or more non-volatile memories 104 that are attachable to or removable from the control board B.

With the above mechanism, there is no need for a different non-volatile memory other than the non-volatile memory 104 storing the encrypted data 104A in order to take over the encryption key A. Therefore, the number of image forming apparatuses 1 to which the above-described mechanism can be applied increases.

In the case of the above mechanism, when the UEFI 102B serving as a boot program is in an operating state, the control board B can take over the encryption key A unique to the control board A. Therefore, even when a failure or the like occurs in which the OS or the like does not activate, the user's setting information can be rescued.

In the case of the above mechanism, the storage of the encryption key data (the data obtained by encrypting the encryption key A with the one-time password) is completed within the same control board A. In other words, there is no need for communications with a device connected to the control board A via a network. Therefore, when the UEFI 102B serving as a boot program is in an operating state, the user's setting information can be rescued.

### Other Exemplary Embodiments

(1) Although the exemplary embodiment of the disclosure has been described above, the technical scope of the disclosure is not limited to the scope described in the embodiment above. It is apparent from the scope of claims that various changes and improvements to the above-described embodiment are also included in the technical scope of the disclosure.
(2) In the case described according to the above exemplary embodiment, the customer engineer replaces the control board 10 (see FIG. 1), but a user of the image forming apparatus 1 (see FIG. 1) may replace the control board 10.
(3) In the case described according to the above exemplary embodiment, there is the one non-volatile memory 104 (see FIG. 1) removable from the control board 10, but there may be the plurality of removable non-volatile memories 104.
(4) In the case described according to the above exemplary embodiment, the encrypted data 104A (see FIG. 2) is encrypted setting information, but the present disclosure is not limited thereto. Examples of the encrypted data 104A may include an address book registered in the image forming apparatus 1, print settings, and captured document images. Documents include images, photographs, and outputs from various application programs. Examples of images and photographs include copy images, facsimile images, and scanned images.
(5) In the case described according to the above exemplary embodiment, the control board 10 of the image forming apparatus 1 is replaced, but the target device is not limited to the image forming apparatus 1. The target device may be any device as long as the encrypted data 104A is stored in the non-volatile memory 104.
(6) According to the exemplary embodiment described above, each processing is executed by any computer. In addition, the arbitrary computer may execute each processing by a processor as hardware, a program as software, or a combination thereof.

In this case, the processor is configured to perform the processes in the exemplary embodiments in cooperation with the program and may function as a unit or a means in the exemplary embodiments.

In addition, the execution order of the processing by the processor is not limited to the described order, and may be appropriately changed. The arbitrary computer may be a general purpose computer, a special purpose computer, a workstation, or any other system capable of performing each processing.

The processor may be configured by one or more pieces of hardware, and the type of hardware is not limited. For example, the processor may be configured by a programmable logic device such as a central processing unit (CPU), a micro processing unit (MPU), or a field programmable gate array (FPGA), a dedicated circuit for executing specific processing, such as an application specific integrated circuit (ASIC), or hardware such as a graphic processing unit (GPU) or a neural processing unit (NPU).

Further, the type of hardware may be a combination of different types of hardware. When a plurality of pieces of hardware is configured to execute one or more processes of a certain processor, the plurality of pieces of hardware may exist in devices physically separated from each other, or may exist in the same device. In addition, according to any exemplary embodiment, the order of the processes performed by the processor is not limited to the order described above, and may be appropriately changed. The hardware is configured by an electric circuit (circuitry) in which circuit elements such as semiconductor elements are combined.

Further, the program may be software such as firmware or microcode. In addition, the program may be, for example, a program module group, and each function thereof may be realized by a processor configured to execute each function. The program may be a program code or a plurality of code segments stored in one or more non-transitory computer-readable media (e.g., storage media or other storage).

The program may be divided and stored in a plurality of non-transitory computer-readable media that exist in devices physically separated from each other. The program code or the code segments may represent procedures, functions, subprograms, routines, subroutines, modules, software packages, classes, or any combination of instructions, data structures, or program statements. The program code or the code segments may be coupled to other code segments or hardware circuits by transmitting and receiving information, data, arguments, parameters, or memory contents.
(7) The exemplary embodiments of the disclosure are also applicable to programs and program products.

### Appendix

(((1)))

An information processing apparatus comprising a processor configured to: when activation satisfies a predetermined condition, receive an input operation for a one-time password; and encrypt a first encryption key used to encrypt first encrypted data stored in a first storage device removable from a first board with the one-time password and store the encrypted first encryption key in the first storage device.

(((2)))

The information processing apparatus according to (((1))), wherein the activation that satisfies the predetermined condition is any one of activation in a state where a specific key is pressed, activation in a state where a specific switch is at a specific position, and activation in a state where a predetermined device is inserted.

(((3)))

The information processing apparatus according to (((1))) or (((2))), wherein the processor is configured to receive input of the one-time password through an operation screen of the information processing apparatus.

(((4)))

The information processing apparatus according to (((3))), wherein the operation screen is a screen for a maintenance mode, and the processor is configured to receive input of the one-time password through the screen for the maintenance mode.

(((5)))

The information processing apparatus according to any one of (((1))) to (((4))), wherein, in a case where, in activation after the first board is replaced with a second board, decryption of the first encrypted data stored in the first storage device taken over from the first board to the second board fails and furthermore encryption key data is present in an encrypted form in the first storage device, the processor is configured to display, on the operation screen, an input screen for the one-time password to be used to decrypt the encryption key data.

(((6)))

The information processing apparatus according to (((5))), wherein the processor is configured to decrypt the first encrypted data stored in the first storage device into plain-text data by using the first encryption key decrypted from the encryption key data with the one-time password, encrypt the decrypted plain-text data into second encrypted data with a second encryption key read from a second storage device that is unremovable from the second board, and write the second encrypted data to the first storage device.

(((7)))

The information processing apparatus according to (((6))), wherein after writing the second encrypted data to the first storage device, the processor is configured to delete the encryption key data from the first storage device.

(((8)))

A program causing a computer to execute a process comprising, when activation satisfies a predetermined condition, receiving an input operation for a one-time password; and encrypting a first encryption key used to encrypt first encrypted data stored in a first storage device removable from a first board with the one-time password and storing the encrypted first encryption key in the first storage device.

(((9)))

The program according to (((8))), the process further comprising, in a case where, in activation after the first board is replaced with a second board, decryption of the first encrypted data stored in the first storage device taken over from the first board to the second board fails and furthermore encryption key data is present in an encrypted form in the first storage device, displaying, on the operation screen, an input screen for the one-time password to be used to decrypt the encryption key data.

What is claimed is:

1. An information processing apparatus comprising:
a processor configured to:
when activation satisfies a predetermined condition, receive an input operation for a one-time password; and
encrypt a first encryption key used to encrypt first encrypted data stored in a first storage device removable from a first board with the one-time password and store the encrypted first encryption key in the first storage device.

2. The information processing apparatus according to claim 1, wherein the activation that satisfies the predetermined condition is any one of activation in a state where a specific key is pressed, activation in a state where a specific switch is at a specific position, and activation in a state where a predetermined device is inserted.

3. The information processing apparatus according to claim 1, wherein the processor is configured to receive input of the one-time password through an operation screen of the information processing apparatus.

4. The information processing apparatus according to claim 3, wherein
the operation screen is a screen for a maintenance mode, and
the processor is configured to receive input of the one-time password through the screen for the maintenance mode.

5. The information processing apparatus according to claim 1, wherein, in a case where, in activation after the first board is replaced with a second board, decryption of the first encrypted data stored in the first storage device taken over from the first board to the second board fails and furthermore encryption key data is present in an encrypted form in the first storage device, the processor is configured to display, on the operation screen, an input screen for the one-time password to be used to decrypt the encryption key data.

6. The information processing apparatus according to claim 5, wherein the processor is configured to:
decrypt the first encrypted data stored in the first storage device into plain-text data by using the first encryption key decrypted from the encryption key data with the one-time password;
encrypt the decrypted plain-text data into second encrypted data with a second encryption key read from a second storage device that is unremovable from the second board; and
write the second encrypted data to the first storage device.

7. The information processing apparatus according to claim 6, wherein after writing the second encrypted data to the first storage device, the processor is configured to delete the encryption key data from the first storage device.

8. A non-transitory computer readable medium storing a program causing a computer to execute a process comprising:
when activation satisfies a predetermined condition, receiving an input operation for a one-time password; and
encrypting a first encryption key used to encrypt first encrypted data stored in a first storage device removable from a first board with the one-time password and storing the encrypted first encryption key in the first storage device.

9. The non-transitory computer readable medium according to claim 8, the process further comprising, in a case where, in activation after the first board is replaced with a second board, decryption of the first encrypted data stored in the first storage device taken over from the first board to the second board fails and furthermore encryption key data is present in an encrypted form in the first storage device, displaying, on the operation screen, an input screen for the one-time password to be used to decrypt the encryption key data.
